(19) United States
(12) Patent Application Publication
(10) Pub. No.: US 2003/0037064 A1
(43) Pub. Date: Feb. 20, 2003

(54) DREware

(76) Inventors: Chadwick M. Choban, St. Paul, MN (US); Robert G. Brooke, Zumbrota, MN (US)

Correspondence Address: TPCG, INC., 706 LOWER JOHNSON CIRCLE, ST. PETER, MN, 56082, US

(21) Appl. No.: 10/126,991

(22) Filed: Apr. 22, 2002

Related U.S. Application Data
(60) Provisional application No. 60/313,680, filed on Aug. 20, 2001.

(51) Int. Cl. G06F 7/00

(52) U.S. Cl. 707/104.1

(57) ABSTRACT

This is a two-tiered software application system, having integrated applications for both a hand held computer for collecting and storing Drug Recognition Expert (DRE) evaluation data (short-term) and a desktop/laptop for manipulation and storage of that data (long-term). The hand held application has the means to digitally capture both drawn depictions where needed, and text data to complete a DRE evaluation. The consecutive screens on the hand held application help to guide the evaluator through the process as to avoid unintentional misrepresentation or absence of data. This system has the means for automatic data transfer from the hand held application into the desktop/laptop application. The desktop/laptop application then has the means for accurate digital storage, reporting, archiving, and distribution of both the drawn depictions and text-based data collected in the interview.

### CROSS REFERENCE TO RELATED APPLICATIONS

This Non-provisional utility patent application claims the benefit of a prior Provisional application for the same invention, filed on Aug. 20, 2001. That application number is 60/313,680.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

This invention relates generally to electronic means for collecting drug recognition data for law enforcement purposes. More particularly, this invention relates to (i) the ability for a Drug Recognition Expert “DRE” officer to collect interview data on a hand held computer that allows operators the ability to electronically gather both graphic depictions, electronically drawn into the hand held computer by the DRE interviewer, as well as text-based information gathered in the same fashion, and (ii) the electronic transfer of this data, both illustrated and text-based, to a desktop computer software application for the purpose of digital storage, reporting, archiving, and distribution purposes.

### BRIEF SUMMARY OF THE INVENTION

This invention provides data collection and a storage system through a hand held computer unit which collects data, both electronically drawn and text-based, and guides the user through all procedural steps of a DRE interview. The hand held portion of this invention, through the use of consecutive information gathering screens, helps to ensure that the DRE officer does not unintentionally exclude any necessary interview data. This data is digitally written into the hand held application via a direct interface with a stylus onto the hand held computer's screen. This data can then be electronically uploaded into the desktop computer application, which can be used to manipulate, further review, digitally store, report on, and distribute the DRE interview data.

### BRIEF DESCRIPTION OF THE SEVERAL VIEWS OF THE DRAWING

(FIGS. 1 through 25: Step by step input screens of the hand held computer's evaluation process.)

FIG. 1: The opening screen for the DREware hand held computer application.

FIG. 2: This screen is used to enter information about a DRE evaluator if that person has never used the application on that particular hand held computer. An evaluator need only enter his/her information into this screen once, and will be stored in the hand held computer application indefinitely, as to avoid future repetitious entry in later evaluations.

FIG. 3: Screen used in the evaluation process to choose pre-entered evaluator information about the DRE evaluator, as entered in the screen illustrated by FIG. 2.

FIG. 4: Screen used to enter information about the officer that arrested the subject that is being interviewed.

FIG. 5: Screen used to enter vital information about the subject of the interview.

FIGS. 6 through 10: Screens that collect preliminary text-based information about the subject, as to their physical condition, appearance, and demeanor.

FIG. 11: This is a mixed screen in that captures both text-based data and drawn depictions of eye movement.

FIG. 12: This is a mixed screen in that it captures both text-based and drawn depiction data of the subject's physical balance and ability to judge short time spans.

FIG. 13: This is a mixed screen in that it captures drawn depictions as to what ends the subject completed a standard ten-step walk and turn test, and a text-based designator to mark if the subject refused the test altogether.

FIGS. 14 and 15: Screen that collects further text-based data on the walk and turn test results that were visually depicted using the screen in FIG. 13.

FIG. 16: This is a mixed screen in that it captures drawn depictions as to what ends the subject completed a standard one leg stand test, and a text-based designator to mark if the subject refused the test altogether.

FIG. 17: Screen that captures text-based data on the one leg stand test results that were visually depicted using the screen in FIG. 16.

FIG. 18: This is a mixed screen in that it captures drawn depictions as to what ends the subject completed a standard finger to nose test, using both left and right hands, and a text-based designator to mark if the subject refused the test altogether.

FIGS. 19 and 20: Screens that collect farther text-based information about the subject, as to their physical conditions.

FIG. 21: Screen that collects preliminary visual depictions of markings or needle tracks on the subject's arms.

FIGS. 22 and 23: Screens that collect text-based information as to drugs the subject admits to consuming or by other means of detection, as well as some information about the DRE officer's shift status and role in the evaluation.

FIG. 24: Screen that collects text-based data outlining the DRE officer's opinion as to what drug agents the subject may be under the influence of.

FIGS. 25 and 26: Screens that collect final evaluation information, and general notes regarding the evaluation.

FIGS. 27 and 28: An actual printed evaluation report generated by the desktop computer application. This report expresses both the text-based data and visual depictions that were captured during the interview process.

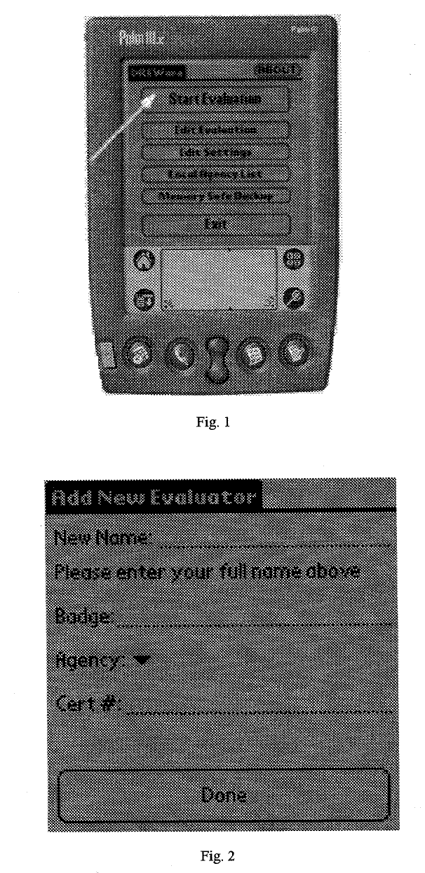

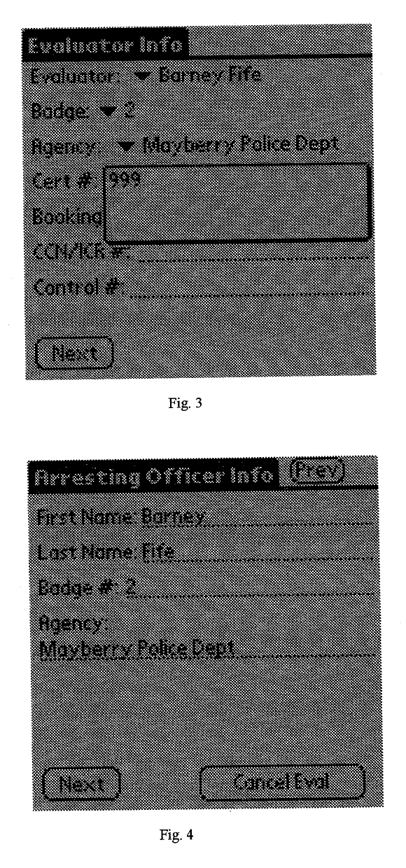

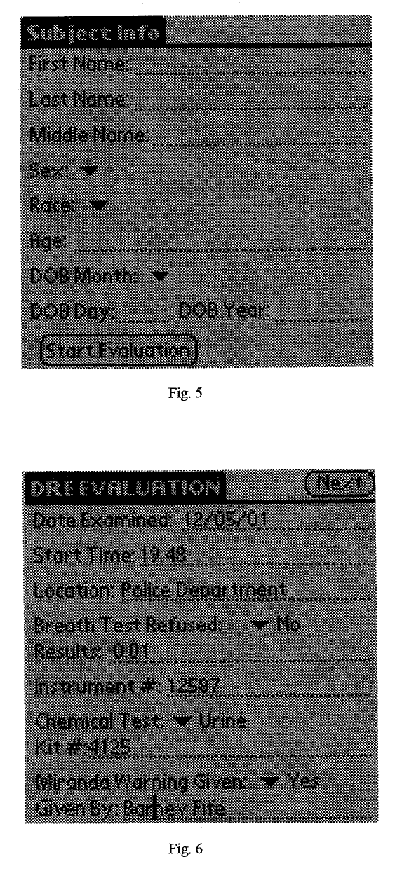

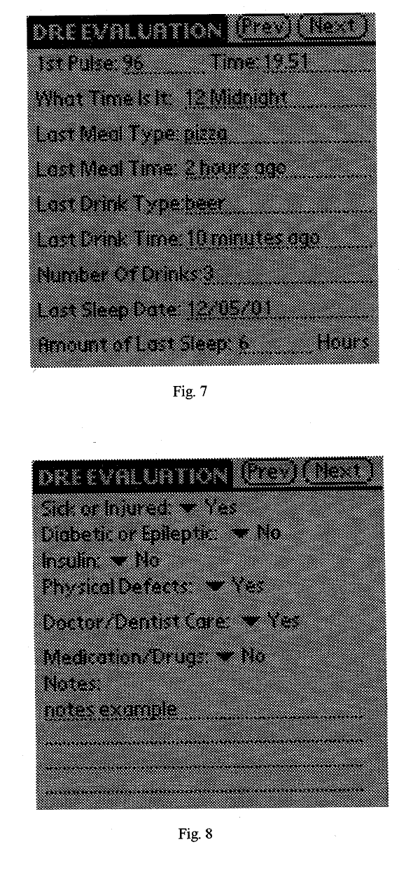

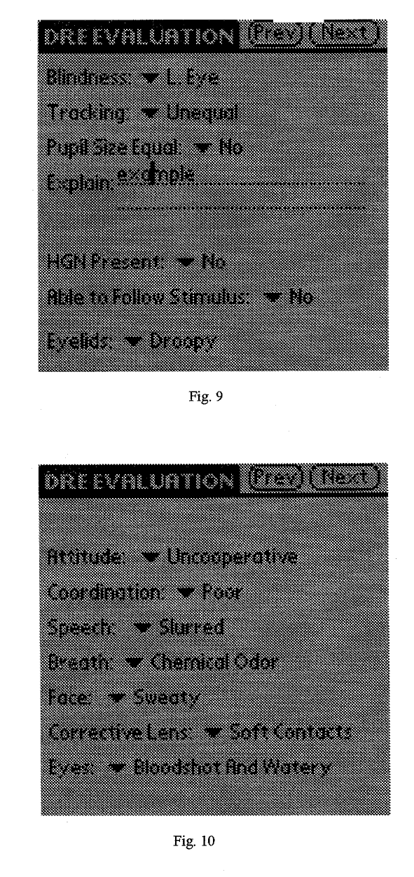

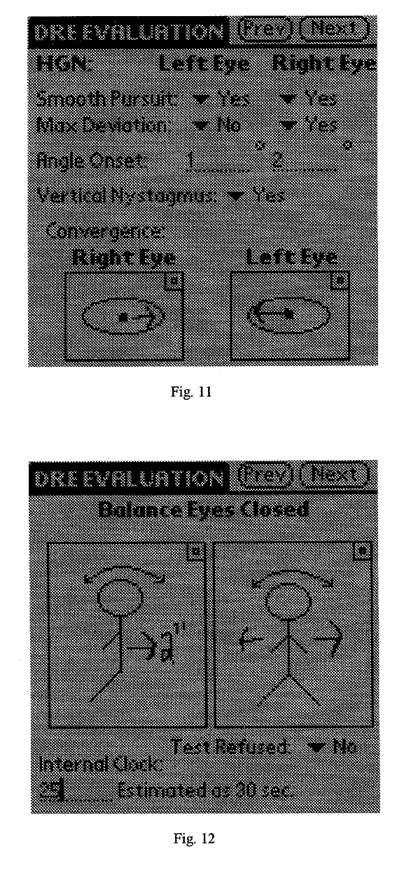

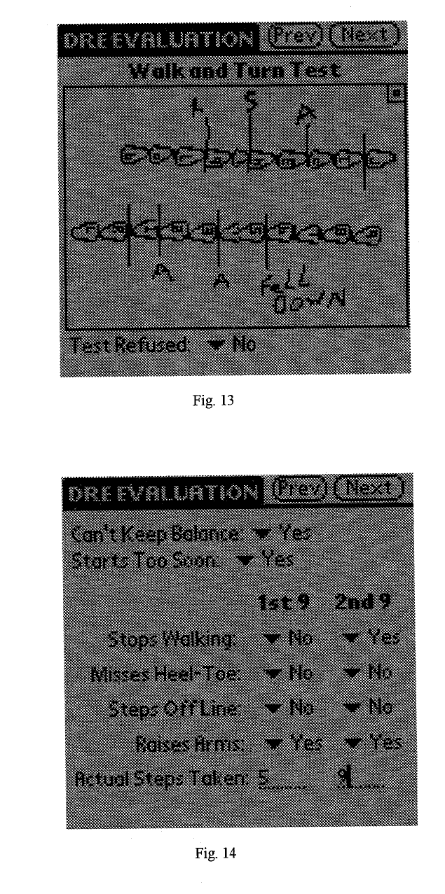

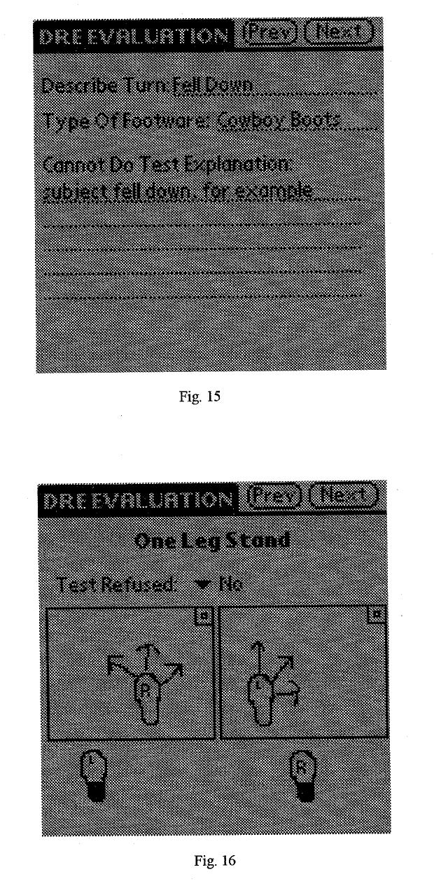

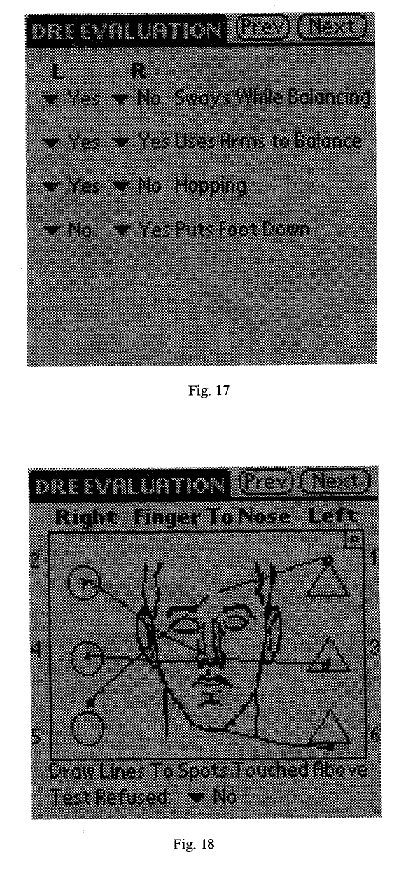

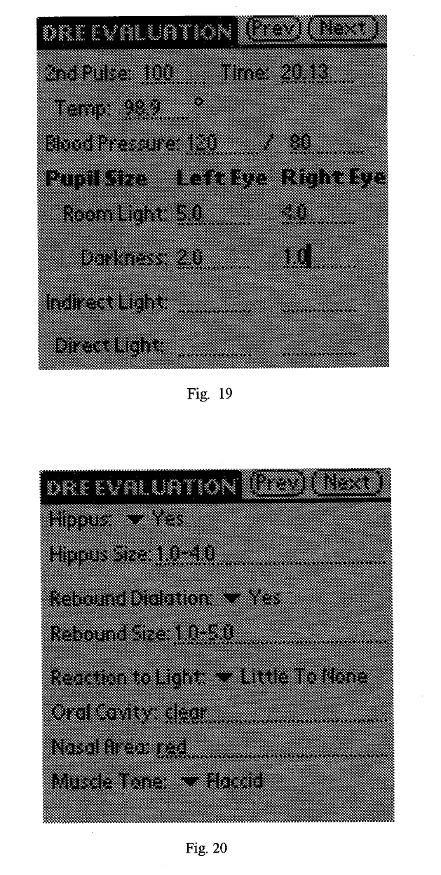

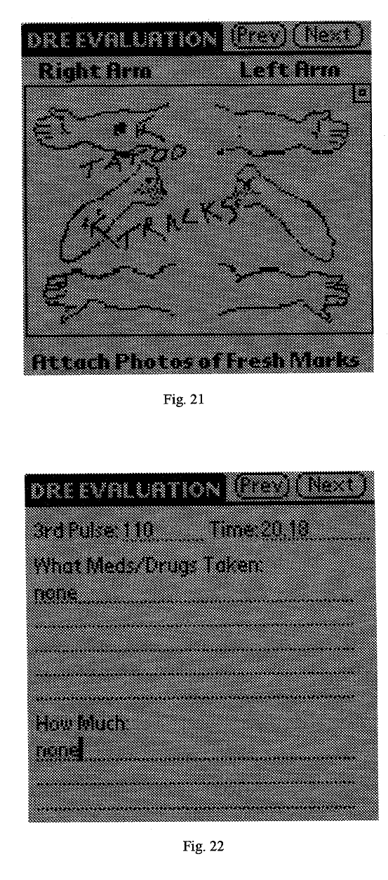

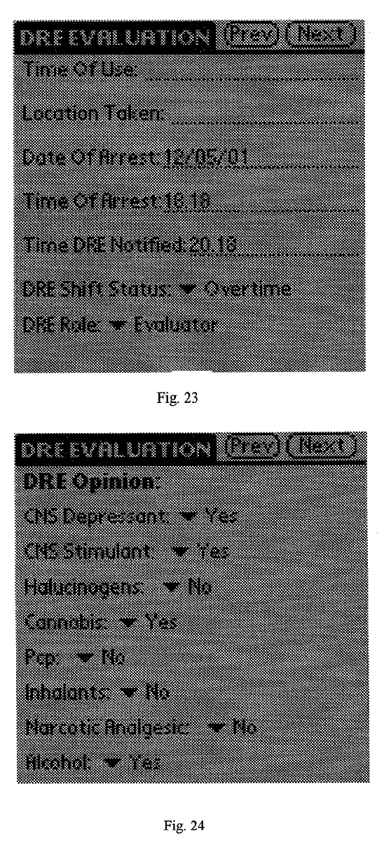

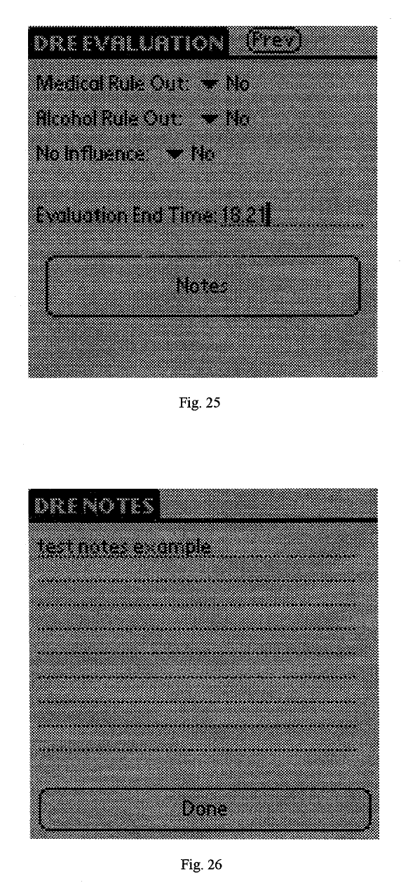

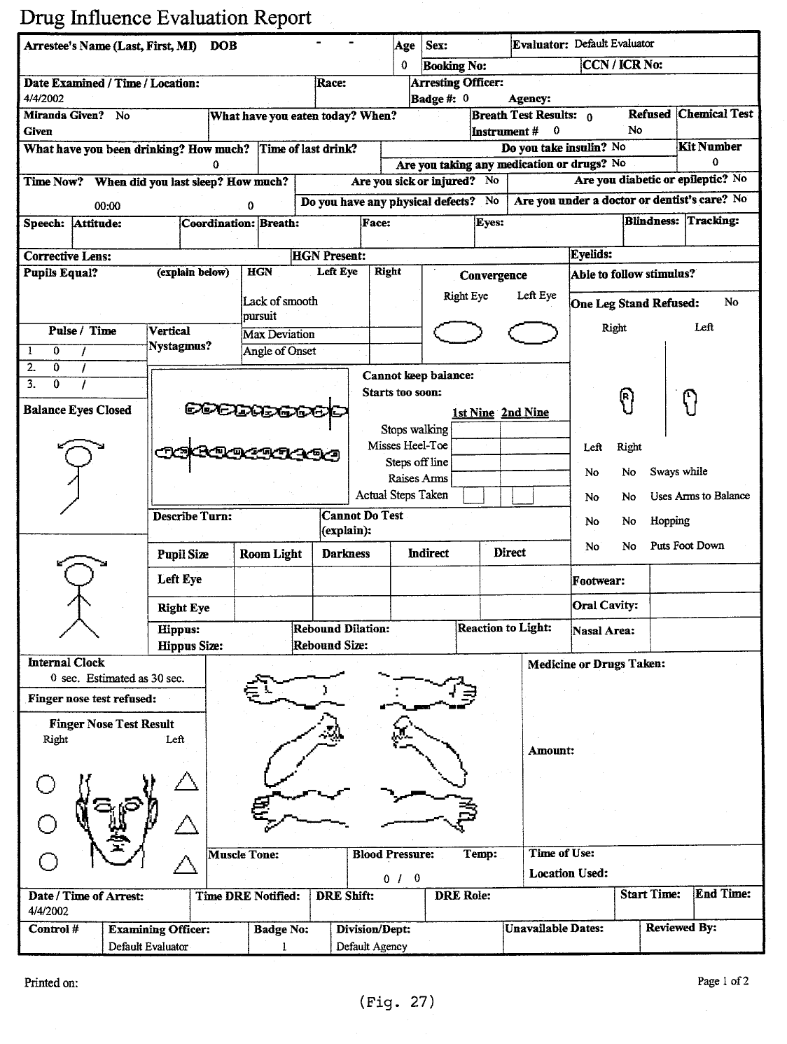

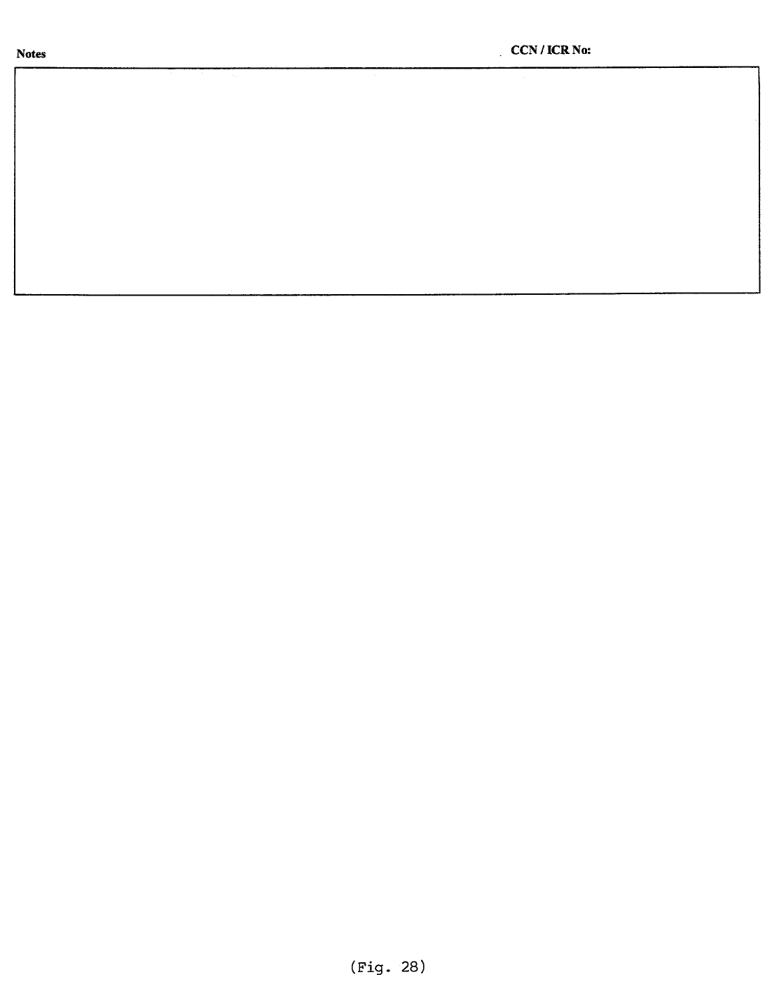

### DETAILED DESCRIPTION OF THE INVENTION

DREware is a software application used to collect data on individuals suspected of drug use. The software is made up of two components; an application that runs on a hand held computer, and an application that runs on a desktop computer.

The hand held computer application is used to collect evaluation data in the field by a police officer that is certified as a Drug Recognition Expert (DRE). The DRE performs the evaluation on a subject of suspected drug use, and inputs both the drawn depictions of movement and visual data, and the text-based data into the hand held computer application while administering the evaluation. The data is comprised of officer information, suspect information, and the data used for evaluation. The evaluation information collected is made up of what food and drink the subject has consumed, along with medications and drugs they have taken. The subject's blood pressure is monitored and the result is input into the hand held computer application along with the results of heart rate checks taken several times during the evaluation. As mentioned previously, there are drawn depictions of movement and visual data that are drawn, as input, into the hand held computer application through the use of the stylus, or pen device, that is included with most commercial hand held computers. Included in this visual data are images representing nystagmus movements of the subject's eyes; indicators of the subject's balance; and representations of his/her ability to negotiate walk and turn and finger to nose tests. The application also includes a diagram screen that allows the DRE to include drawings of markings of previous drug use found on the subject's arms. If a blood or urine sample is collected, the application records the collection kit information.

The DRE also records their opinion as to what categories of drugs the subject has been using and/or if alcohol use is suspected. The DRE also has the ability to record notes on information about the evaluation that need to be documented. Once the evaluation is completed, the DRE can exit the hand held computer application and the information is stored in a database until the hand held computer is synchronized with the desktop computer application.

The desktop computer application is used to view and report on an evaluation once it is moved off the hand held computer. When the hand held computer is synchronized with the desktop computer application, the desktop computer application moves the DREware hand held computer application databases into the desktop computer application. The desktop computer application retains a list of every evaluation that has been synchronized into the desktop application along with any evaluations that have been imported. From the main desktop computer application screen, an evaluation form can be viewed and printed. When this form is activated, the desktop computer application draws out information from the database on that particular evaluation that is being viewed, along with its drawn images, and outputs the entire data set into a printable form. The desktop computer application combines the drawn data with background images and creates bitmaps that are included on the printable form. The desktop computer application can also be used to enter evaluation data, exclusive of any drawn data, which can only be input on the hand held computer application. The desktop computer application can also be used to edit evaluations and add later obtained lab results of urine or blood tests.

The desktop computer application allow reports to be generated with information gathered according to a specific need, for example: To categorize drug use by age group; to determine the frequency of occurrence by drug category; or to review evaluations by a specific DRE. The desktop application is also able to import and export evaluations to facilitate a flow of data to a state coordinator or agency responsible for data collection and reporting. The desktop application also allows for an export format that enables data to be uploaded to a website that will act as a central repository for a national database.

In previous processes, all of the information listed above had been collected using a pre-printed evaluation form, using a pen or pencil to manually draw graphic depictions and collect text-based data necessary to complete the interview. If the user chose to do so, they could then enter this information into a commonly used pre-formatted Microsoft Access database file. What distinguishes our DREware application is that the collection of both graphic and text-based information is done in a digital format on a hand held computer, and then automatically synchronized, digitally, to the desktop computer application, allowing the DRE officer to, for the first time, automatically store both the

What is claimed is:

1. A means of mobile, digital data collection and temporary storage for DRE evaluators comprised of;
a. A software application, (to be installed on a hand held computer obtained separately), that allows a DRE evaluator to digitally collect and automatically store both graphic depictions and text-based data from many evaluations, on a temporary basis.
b. A means within the hand-held software application to allow the DRE evaluator to use the stylus (pen), included as part of the hand held computer, to interact directly with the application to record both graphic depictions and text-based data.
c. Consecutive, guiding screens within the handheld software application that lead the evaluator through the steps of a DRE interview as to help avoid unintentional incompleteness.
d. A function within the handheld software application that allows for the application itself to be backed up onto an external memory device, so that it may be manually transferred to another, or many other, hand held devices. (Memory device to be obtained separately, as peripheral to hand held computer.)
e. An included means within the handheld software application to automatically upload the evaluation data, in a digital format, into an application written for use on a desktop or laptop computer.

2. A means of long-term storage, reporting, archiving, distribution, and manipulation of the evaluation data, both graphic depictions and text-based, collected in the hand held application, comprised of:
a. A software application, (to be installed on a desktop or laptop computer obtained separately) which acts as a repository of digital data uploaded to it, as described in claims 1-e.
b. A means within the desktop software application to sort and filter all evaluation records based on either DRE certification number, (or a number unique to the evaluator), DRE name, type of drug used, date of evaluation, subject age, agency name, or all records.
c. A means within the desktop software application to select any one of the records found by using the means listed in 2-b or by other means, to change, update, edit, delete, or add to evaluation data that has either been uploaded from the hand held software application or that have been created using the desktop/laptop software application.
d. A means within the desktop software application to complete new evaluation records in the application using only the desktop or laptop computer, (not the hand held computer).
e. A means within the desktop software application to select a specific record in the application and either view and/or print it, in a report format that displays all types of data in that particular record, including graphic depictions drawn into the handheld software application and text-based data collected either in the handheld software application or entered into the desktop/laptop software application.
f. A means within the software application that allows the user to:
(i) export any data sorted or filtered in a similar fashion to 2-b.
(ii) import any data sorted or filtered in a similar fashion to 2-b.
The exported/imported data is in the form of a database that can be used by other people, such as superiors in the evaluator's organization, using the same desktop software application. This exported database file can be transferred via any electronic means or media to the person who is to import it. It may also be opened and manipulated with many third party database applications for the sake of manual, or custom reporting.
g. A means within the desktop software application to view enter and store verified lab results for each interview record, and visually compare correct vs. incorrect DRE evaluator diagnosis to these results.
